(19) United States
(12) Patent Application Publication
(10) Pub. No.: US 2010/0224119 A1
(43) Pub. Date: Sep. 9, 2010

(54) Wind Detector Devices and Methods of Detecting Wind

(76) Inventor: Duane Sheldon Morris, Kamiah, ID (US)

Correspondence Address: WELLS ST. JOHN P.S., 601 W. FIRST AVENUE, SUITE 1300, SPOKANE, WA, 99201, US

(21) Appl. No.: 12/718,287

(22) Filed: Mar. 5, 2010

Related U.S. Application Data
(60) Provisional application No. 61/209,265, filed on Mar. 6, 2009.

(51) Int. Cl. G01W 1/00; G01P 13/00

(52) U.S. Cl. 116/214; 73/170.04

(57) ABSTRACT

This invention is directed to an exemplary wind detector device. The device includes a container having an interior and a nozzle in fluid communication with the interior. The device further includes powder in the interior of the container and a strip of material having first and second ends. The first end is secured to the container and the second end is configured to be secured to a support structure such as clothing.

### CROSS REFERENCE TO RELATED APPLICATION

This application claims priority to U.S. provisional application No. 61/209,265, filed Mar. 6, 2009, the entire disclosure of which is herein incorporated by reference.

### TECHNICAL FIELD

This invention relates to wind detector devices and methods of detecting wind.

### BACKGROUND OF THE INVENTION

Various disciplines, jobs, and recreational activities are enhanced if wind detection and general wind measurements are performed. For example, fire science and management, environmental jobs, and various sport enthusiast activities such as hang gliding and hunting all benefit from detecting and measuring the wind during various stages of the activities.

Regarding hunting, an experienced hunter will rely on wind detection and measurement to carefully select his or her position relative a living target such as game animals. The reason being is that most game animals have such a keen sense of smell that the animals will avoid allowing a hunter to be positioned within the kill range. To diminish and avoid detection by the animal, an experienced hunter will account for wind direction during the pursuit and position himself downwind from the animal.

Further regarding hunting, wind direction and speed (collectively wind velocity) is important to hunters, particularly bow hunters, who need to determine the wind velocity to increase the accuracy of the arrow (or bullet). The wind velocity that influences an arrow during its trajectory toward a target or animal will have a definite impact upon the accuracy of the arrow. No hunter wants to miss a kill shot due to wind only to strike the animal at a location where the animal may take days to die. Accordingly, there is always a need to improve wind detector device designs and improve methods of wind detection to facilitate and increase the ease, speed and efficiency of wind detection while maintaining the accuracy of measuring wind velocity (speed and direction).

The invention is only limited by the accompanying claims as literally worded, without interpretative or other limiting reference to the specification, and in accordance with the doctrine of equivalents.

Other aspects and implementations are contemplated.

### BRIEF DESCRIPTION OF THE DRAWINGS

Preferred embodiments of the invention are described below with reference to the following accompanying drawings.

FIGS. 1(A)-1(E) are perspective views of an exemplary wind detector device according to one of various embodiments of the invention and further illustrated is an exemplary method of detecting wind according to one of various embodiments of the invention.

FIG. 2 is an elevational side view of one exemplary container for the wind detector device of FIG. 1 with the container in a closed position.

FIG. 3 is an elevational side view of the container of FIG. 2 with the container in a partial open position relative the orientation of FIG. 2.

FIG. 4 is an elevational side view of the container of FIG. 2 with the container in an open position.

FIG. 5 is an elevational side view of the container of FIG. 4 with the container being shaken according to one exemplary method of various embodiments of the invention for detecting wind.

FIG. 6 is an elevational side view of the container of FIG. 5 with the container being squeezed to release contents therein according to one exemplary method of various embodiments of the invention for detecting wind.

FIG. 7 is a collective view of exemplary components of an exemplary wind detector device according to one of various embodiments of the invention.

FIG. 8 is an elevational front view of an exemplary container cover of an exemplary wind detector device according to one of various embodiments of the invention.

FIG. 9 is an elevational front view of an exemplary retractable reel of an exemplary wind detector device according to one of various embodiments of the invention.

FIG. 10 is an elevational side view of the exemplary retractable reel of FIG. 9.

FIG. 11 is an elevational rear view of the exemplary retractable reel of FIG. 9.

FIG. 12 is the elevational front view of the exemplary retractable reel of FIG. 9 with the retractable reel being used in an exemplary method step according to one of various embodiments of the invention.

FIG. 13 is a perspective view of an exemplary method step of preparing an exemplary wind detector device according to one of various embodiments of the invention.

FIG. 14 is a view of a subsequent exemplary method step of that illustrated in FIG. 13 according to one of various embodiments of the invention.

FIG. 15 is a view of a subsequent exemplary method step of that illustrated in FIG. 14 according to one of various embodiments of the invention.

FIG. 16 is a view of a subsequent exemplary method step of that illustrated in FIG. 15 according to one of various embodiments of the invention.

FIG. 17 is an elevational front view of another exemplary retractable reel with another component of an exemplary wind detector device according to one of various embodiments of the invention.

FIG. 18 is a perspective view of another exemplary wind detector device according to one of various embodiments of the invention.

FIG. 19 is a perspective view of another exemplary wind detector device according to one of various embodiments of the invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

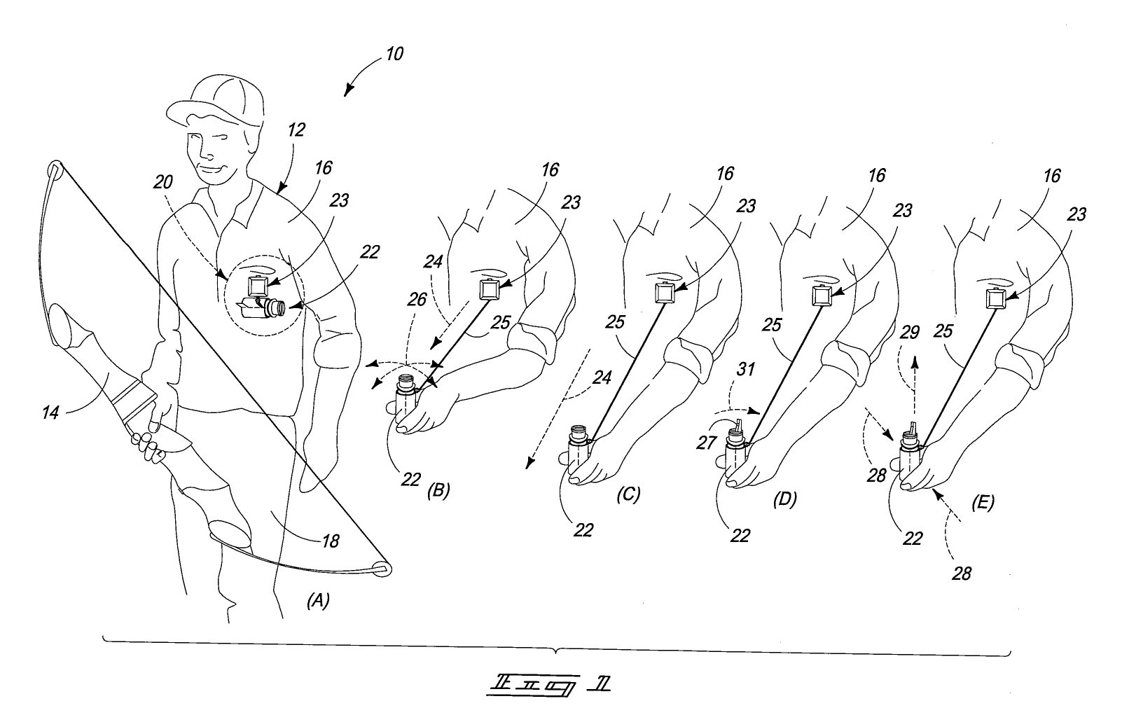

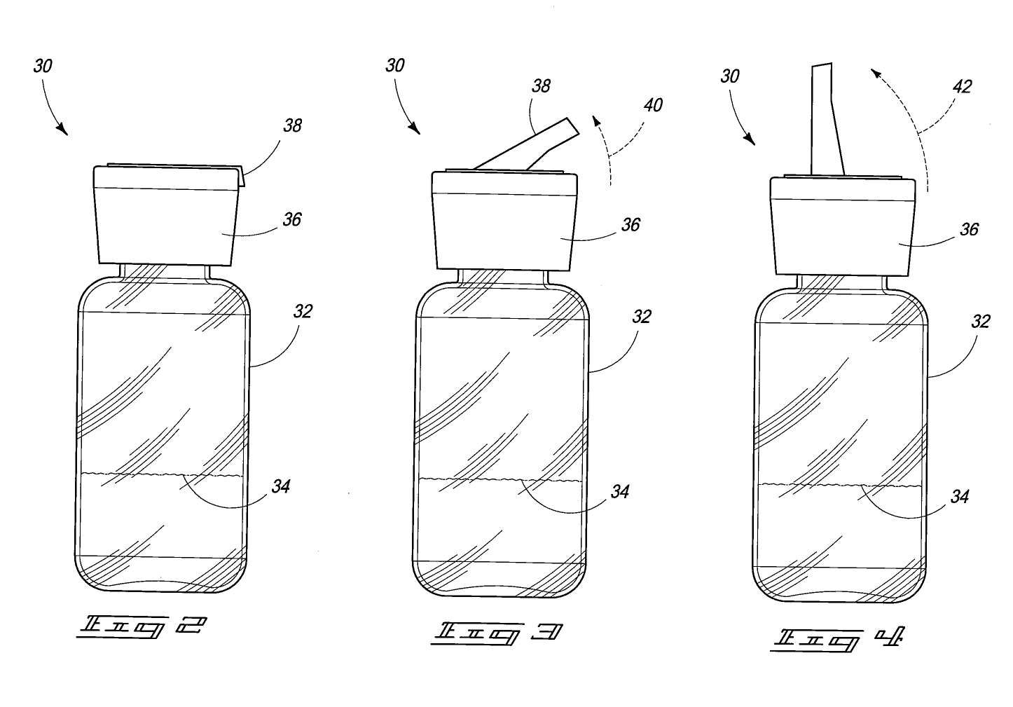

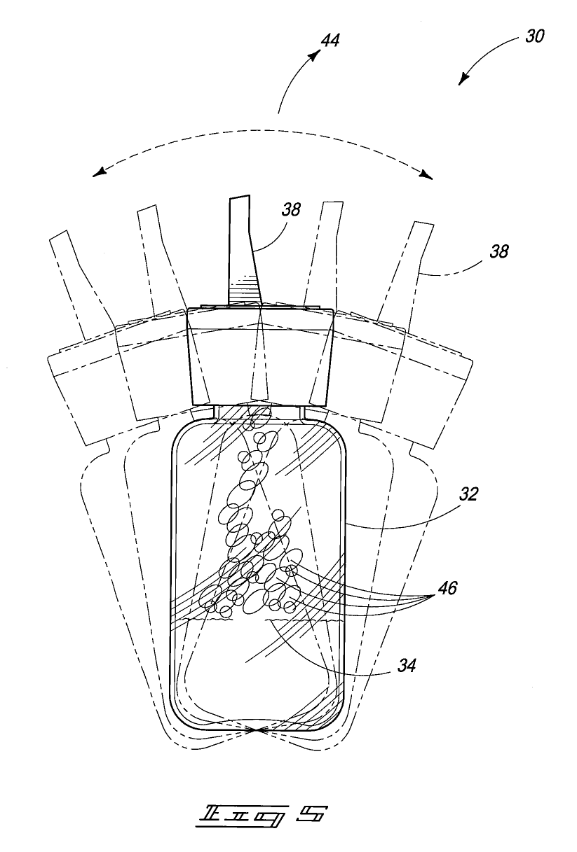

Referring to FIGS. 1(A)-1(E), an exemplary, inventive wind detector device 20 is illustrated according to one of various embodiments of the invention. Moreover, FIGS. 1(A)-1(E) further illustrates an exemplary, inventive method 10 of detecting wind according to one of various embodiments of the invention. Referring to FIG. 1(A), a person, such as a hunter 12 with a bow 14, has the exemplary wind detector device 20 secured to an article of clothing or other support structure, and in this example, to a shirt 16. Alternatively, the wind detector device 20 could be secured to slacks (pants) 18, a hat (not referenced with a number) and a belt, jacket, coat (not shown). In this exemplary embodiment, an exemplary wind detector device 20 includes a container 22 secured to the shirt 16 by a retractable reel 23.

Referring to FIG. 1(B), another exemplary method step of method 10 for using the wind detector device 20 is illustrated in a subsequent method step to that illustrated in FIG. 1(A) according to one of various embodiments of the invention. Hunter 12 has grabbed the container 22 with a hand, moved the container a selected distance from the body along direction 24, and begins to shake 26 the container 22 and contents therein. In one exemplary method step, during the shaking 26, an exemplary nozzle (referenced as 27 in FIG. 1(D)) of container 22 is in an exemplary closed position wherein nozzle 27 is generally planar with an upper surface of a top (not referenced here for simplicity and discussed more thoroughly subsequently) of container 22. In the closed position, an orifice in nozzle 27 is not in fluid communication with the contents located in an interior of container 22. It should be understood that during this method step, an exemplary length of an exemplary strip of material (can additionally be referred to as a string, cord and extension) 25 is unwound (unreeled) from retractable reel 23 and extends between a body of retractable reel 23 and container 22. That is, an exemplary retractable reel 23 has a biased reel (not seen due to being in body of retractable reel 23) wherein an end of the strip of material 25 is secured to the biased reel. The biased reel is biased to rotate thereby rolling or reeling the string of material 25 back into the body of the retractable reel 23. The biased reel is rotatably configured to roll substantially an entire length of the strip of material 25 back into the body of the retractable reel 23.

Referring to FIG. 1(C), another exemplary method step of method 10 for using the wind detector device 20 is illustrated in a subsequent method step to that illustrated in FIG. 1(B) according to one of various embodiments of the invention. Hunter 12 has extended his arm further to move the container 22 in direction 24 further away from the body (and away from the shirt 16 and body of retractable reel 23). Alternatively, this method step can be considered optional as hunter 12 would not have to further extend his arm relative the selected distance of FIG. 1(B) before performing the subsequently-described method steps. It should be understood that any selected distance of spacing between the container 22 and hunter 12 is only limited by the length of the arm or any exemplary length of the exemplary strip of material 25.

Referring to FIG. 1(D), another exemplary method step of method 10 for using the wind detector device 20 is illustrated in a subsequent method step to that illustrated in FIG. 1(C) according to one of various embodiments of the invention. Hunter 12 pivots (or flips) the nozzle 27 along a general direction 31 from the exemplary closed position to the shown exemplary open position. In the open position, nozzle 27 is substantially perpendicular to the upper surface of the top of container 22. Additionally, in the open position the orifice in nozzle 27 is in fluid communication with the contents located in the interior of container 22. An alternative method step includes pivoting of nozzle 27 to the open position before the hunter 12 extends the arm to the distance from the body shown. Still further, and alternatively, at any selected time during the movement of container 22 along direction 24 and at any selected spacing from the body of hunter 12, nozzle 27 can be pivoted to the open or closed positions of container 22.

Referring to FIG. 1(E), another exemplary method step of method 10 for using the wind detector device 20 is illustrated in a subsequent method step to that illustrated in FIG. 1(D) according to one of various embodiments of the invention. Hunter 12 squeezes 28 container 22 to force and expel (or spray) contents therein to move from the interior of container 22, through the orifice of nozzle 27, to exit container 22 in general direction 29. Prevailing ambient or environmental wind conditions will then influence the motion of the container contents which have exited container 22 to flow generally in the same direction and speed as the prevailing wind conditions. Consequently, the hunter 12 using the inventive wind detector device 20 in the disclosed inventive method 10 steps will be able to determine the prevailing wind conditions.

Another exemplary method step of method 10 for using the wind detector device 20 in a subsequent method step to that illustrated in FIG. 1(E) according to one of various embodiments of the invention, and not shown, includes pivoting or folding the nozzle 27 to the closed position. Additionally, another exemplary method step of method 10 for using the wind detector device 20 in a subsequent method step to that illustrated in FIG. 1(E) according to one of various embodiments of the invention, and not shown, includes bringing the container 22 back to being positioned adjacent the body of the retractable reel 23 or hunter 12. In this method step, the retractable reel 23 draws or reels in (or rerolls) the strip of material 25 with the container 22 ultimately to hang from the body of retractable reel 23 and shirt 23 as shown in FIG. 1(A). It should be understood that in this stored position adjacent the hunter 12, any one of the previously-described exemplary method steps can be repeated, including repeatedly squeezing container 22 to determine the then existing wind conditions. That is, the inventive wind detector device 20 is capable of a plurality of repeated measurements or gauging of prevailing wind conditions.

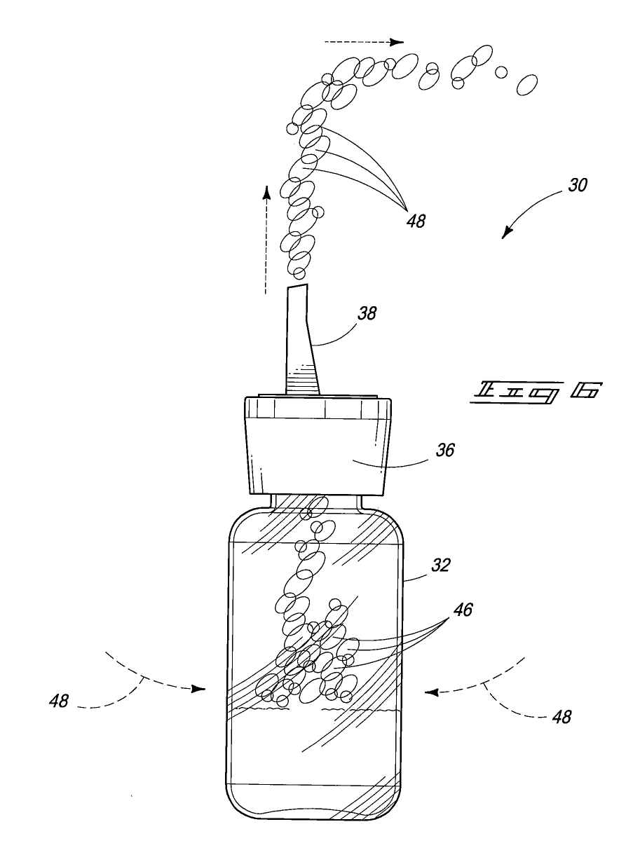

Referring to FIG. 2, an exemplary container or dispenser (or nebulizer, or atomizer) 30 according to one of various embodiments of the invention is described. It should be understood that container 30, with exemplary contents 34 therein, can form one entire exemplary embodiment of a wind detector device according to one of various embodiments of the invention. This exemplary embodiment illustrates container 30 in the closed position. An exemplary container 30 is a plastic squeeze bottle and includes a compressible polymeric housing 32. One exemplary housing 32 includes a 1-ounce polypropylene squeeze bottle closed by a cap, lid or top 36. An exemplary cap 36 includes an exemplary nozzle (or snout) 38 (as previously described in FIG. 1 directed to nozzle 27) which has pivoting or folding capabilities. As further stated previously, nozzle 38 is generally planar with an upper surface of top 36 of container 30. Moreover, the exemplary nozzle 38 has an orifice (or bore or passage) extending therethrough with an exemplary diameter of about 0.15 centimeter, and alternatively, having diameters ranging from about 0.5 centimeters to about 4 centimeters.

Still referring to FIG. 2, an exemplary housing 32 of container 30 includes an outer peripheral body or surface that is translucent or transparent, or has a degree of translucency or transparency. Alternatively, the outer peripheral body or surface of housing 32 can be opaque, or a degree of opaqueness. If translucent or a degree thereof, contents 34 within container 30 can be seen. Exemplary contents 34 are described subsequently and include powder substances. It should be understood other exemplary containers 30 include alternative sizes, for example, ranging from 2-ounce bottles to 32-ounce bottles (and greater), and any integer between, and any fraction between the integers, representing fluid ounce bottle sizes.

Referring to FIG. 3, container 30 is illustrated with nozzle 38 partially positioned between the open and closed positions after having moved from the closed position of FIG. 2 along direction 40 to the position shown.

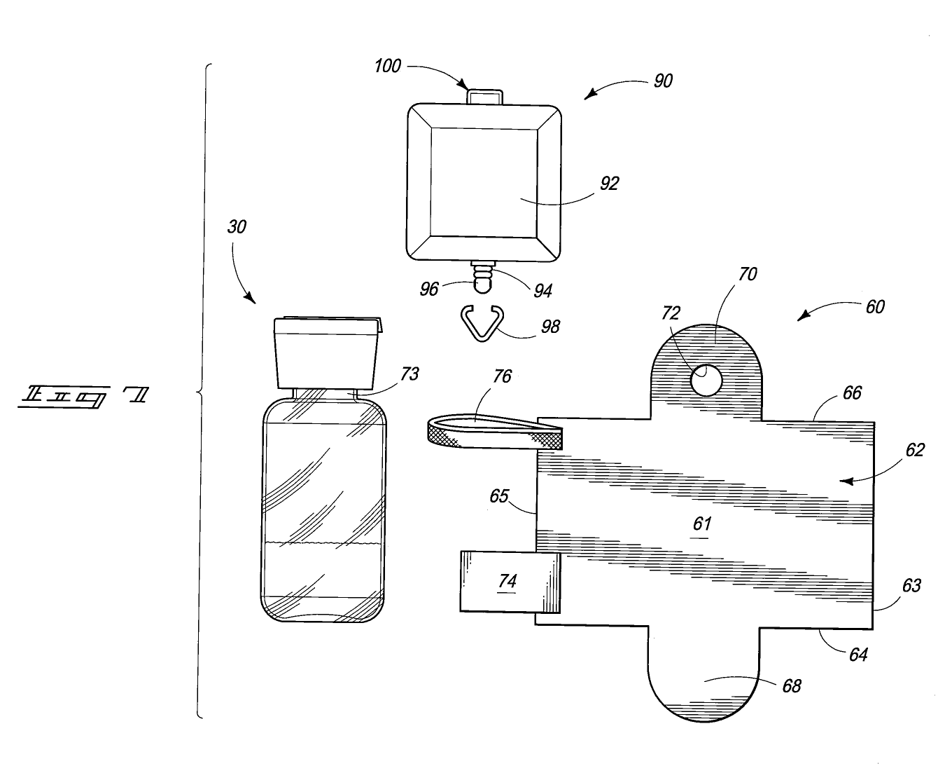

Referring to FIG. 4, container 30 is illustrated with nozzle 38 positioned in the open position after having moved from the partial position of FIG. 3 along direction 42 according to one of various embodiments of the invention. In this open position, nozzle 38 is substantially perpendicular to the upper surface of the top 36 of container 30 and the orifice in nozzle 38 is in fluid communication with the contents 34 located in the interior of container 30.

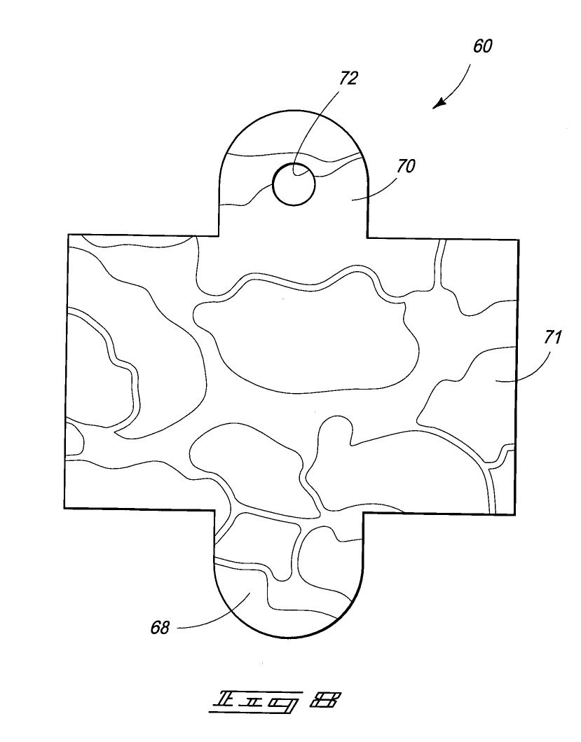

Referring to FIG. 5, the effects of shaking 44 of container 30 is illustrated according to one of various embodiments of the invention, and a cloud (or cloud of smoke) 46 is formed from contents 34 and resides in the unfilled (or air-filled) portion of the interior of container 30. Exemplary embodiments of contents 34 that produce cloud 46 during shaking 44 include finely-divided particles or powder-like material. An exemplary powder-like material includes any one of the following substances: fire extinguisher powders or agents (or fire retardant powder) such as ammonium phosphate, mono-ammonium phosphate and ammonium sulfate; baking soda such as sodium bicarbonate; soil that is filtered into finely-divided particles and talcum powder such as magnesium trisilicate.

It should be understood that any one of these substances alone can form the entire volume of contents 34 within container 30 of an exemplary wind detector device, and alternatively, any combination of these substances can form the entire volume of contents 34. Moreover, other exemplary embodiments of the invention include combining the following material(s) with any one of the substances just described, or added with any combination of the substances just described, to form contents 34: pigment agents; scenting or masking agents such as acorn, pine, apple or cedar; magnesium aluminum silicate (attapulgite clay); tricalcium phosphate and mica. Any one alone of these materials, or any combination of these materials, can be added to the substances previously described to form contents 34.

It should be understood that one third (⅓) of the interior volume of container 30 can be filled with contents 34. Moreover, it should be understood that one sixth (⅙), one fifth (⅕), one fourth (¼), one half (½), two thirds (⅔), three fourths (¾) or seven eights (⅞) of the interior volume of container 30 can be filled with contents 34. Furthermore, it should be understood that a range of the interior volume of container 30 can be filled with contents 34, for example, about one tenth ( 1/10) to about nine tenths ( 9/10). Still further, it should be understood that substantially an entirety of the interior volume of container 30 can be filled with contents 34. Additionally, it should be understood that container 30 can be repeatedly filled with contents 34.

Referring to FIG. 6, the housing 32 of container 30 is illustrated being squeezed along direction 48 according to one of various embodiments of the invention. The squeezing permits the air and cloud 46 within container 30 to be expelled into the environment to establish cloud (or cloud of smoke) 48 exterior to container 30. The hunter may then observe the direction and speed of travel in the ambient air of cloud 48 in order to establish wind conditions.

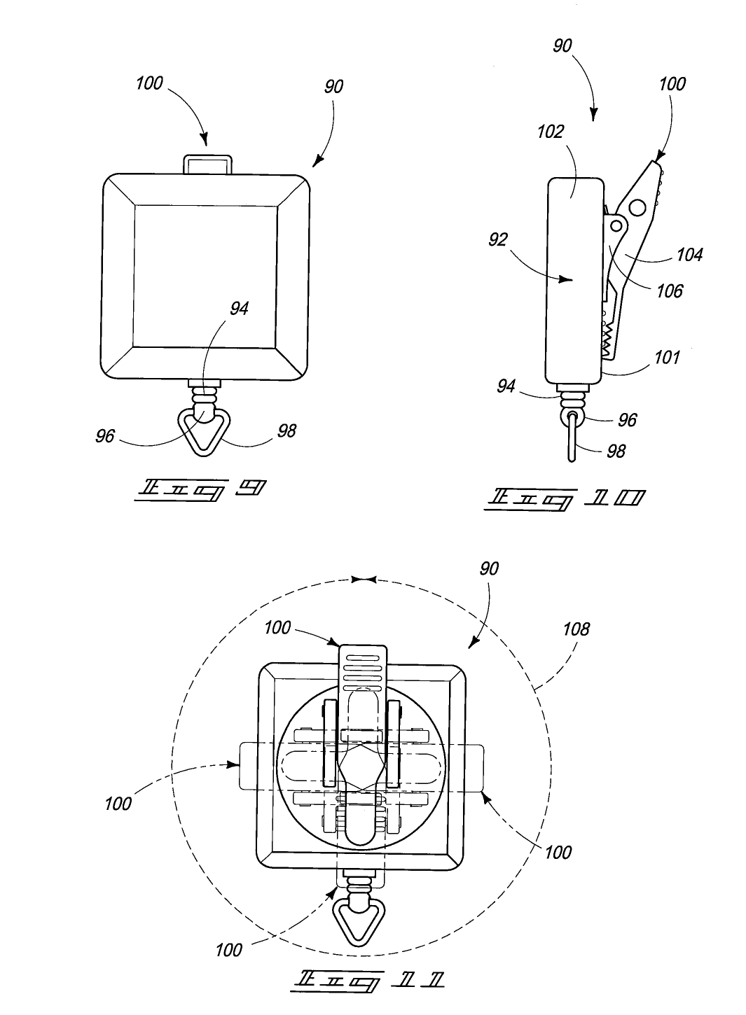

Referring to FIG. 7, another embodiment of an exemplary wind detector device and is illustrated as a collection of different components according to one of various embodiments of the invention. Container 30 has been previously described. An exemplary container cover (receptacle, wrap or sock) 60 and an exemplary retractable reel 90 are further described.

Still referring to FIG. 7, cover 60 is a patterned piece of at least one of the following materials: various cloth and fabric materials; various fibrous and threaded materials; various rubbers; various synthetic rubbers such as neoprene; various nylon materials; and various leathers. One or any combination of these materials can form cover 60. In one exemplary embodiment of the invention, cover 60 is patterned from a sheet of neoprene, such as 2 mm neoprene. Exemplary dimensions for an exemplary sheet of neoprene before patterning into a cover 60 can measure about 5 inches by about 4 inches. Other aspects and implementations of exemplary dimensions for exemplary sheets of neoprene are contemplated.

Still referring to FIG. 7, a back side or portion 61 of cover 60 is illustrated after being patterned from the original sheet. The back side 61 of cover 60 will ultimately be positioned against or adjacent container 30 in the final construction. The pattern of cover 60 includes a central rectangular portion 62 having a right side 63 (from this perspective), a bottom side 64, a left side 65 and a top side 66. An exemplary dimension between the right side 63 and the left side 65 is about 4⅛ inches. An exemplary dimension between the top side 66 and the bottom side 64 is about 2⅝ inches. The central rectangular portion 62 is configured to eventually be wrapped around container 30 and form generally a cylindrical configuration.

Still referring to FIG. 7, extending from bottom side 64 of cover 60 is a lower curved portion 68 that is configured to be positioned over a bottom portion of container 30. Extending from top side 66 is an upper curved portion 70 which is configured to be received over a neck portion 73 of container 30 via opening 72. An exemplary diameter for opening 72 is about 7/16 inch. An exemplary dimension measured from the arc section of the upper curved portion 70 to the arc section of the lower curved portion 68 is about 5 inches. An exemplary width dimension (oriented parallel with top side 66) of the upper curved portion 70 is about 1¼ inch. An exemplary width dimension (oriented parallel with bottom side 64) of the lower curved portion 68 is about 1½ inch.

An optional tag 74 extends across left side 65 and can be used to identify a company, manufacturer or any other informative disclosure. An exemplary loop 76 extends across left side 65 and is used for securement to retractable reel 90. An exemplary loop 76 is a ¼ inch utility cord with an exemplary length of about 1½ inch which ultimately is folded in the loop form. Both tag 74 and loop 76 can be sewn or glued to back side 61 of cover 60. Alternatively, one or both of tag 74 and loop 76 can be placed in the shown positions and later secured into cover 60 during the final forming of cover 60 into the receptacle to receive container 30. The final forming of cover 60 includes the right side 63 being attached to left side 65 and the bottom curved portion 68 being folded to attach to the bottom side 64. The attachment process during the final forming of cover 60 can be performed by a sewing or gluing process.

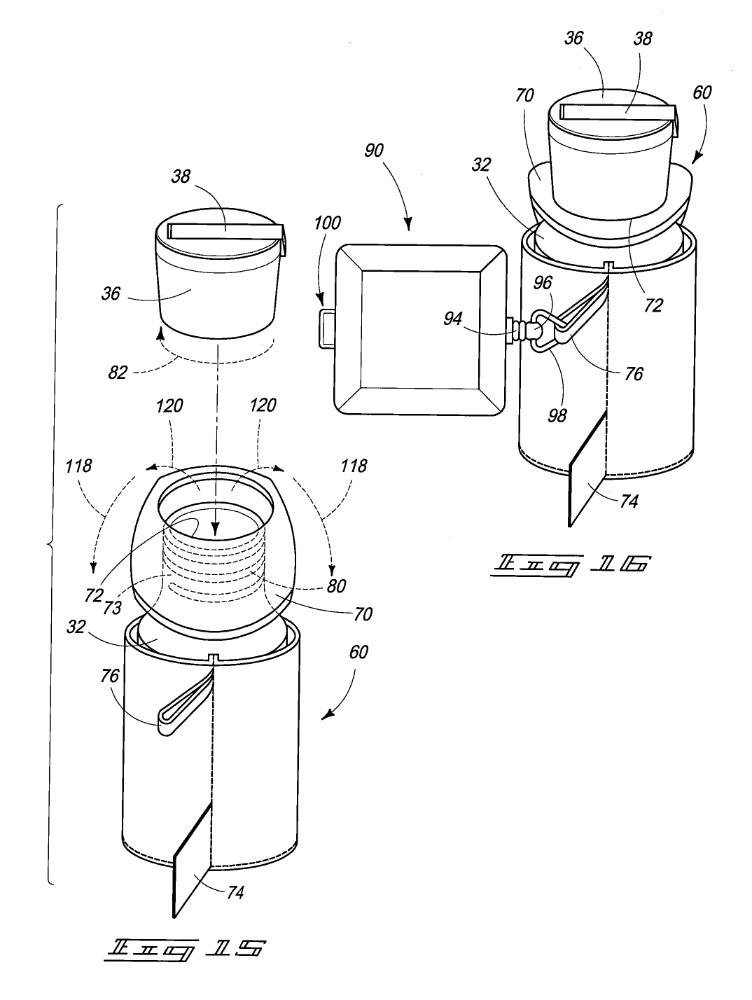

Still referring to FIG. 7, an exemplary retractable reel 90 is illustrated with body 92 and includes an attachment clip 100 located on an opposite side and discussed more thoroughly subsequently. Retractable reel 90 further includes a string or line stop 94 to prevent a strip of material 110 (shown and referenced in FIG. 12) from completely and irretrievably recessing into the body 92 of retractable reel 90. Stop 94 includes a receiving ball 96 having an opening extending entirely through (not referenced or seen from this view) to receive opposite ends of a v-shaped ring 98 wherein loop 76 is threaded through ring 98 to complete attachment of cover 60 to retractable reel 90. In this figure, ring 98 is shown to be opened with opposite ends spread apart for positioning the opposite ends in opposite sides of opening of receiving ball 96.

Referring to FIG. 8, an exemplary front side 71 of cover 60 is illustrated according to one of various embodiments of the invention without optional tag 74 and loop 76 removed to facilitate ease of understanding. The exemplary front side 71 shown is a camouflage design to blend in with the background environment for hunters. Alternatively, other designs can be included, for example, different colors completely provided over the front side 71. Furthermore, additional pattern configurations can be incorporated into exemplary covers 60 according to various embodiments of the invention. For example, lower curved portion 68 and upper curved portion 70, one or both, could be patterned as a square or rectangle.

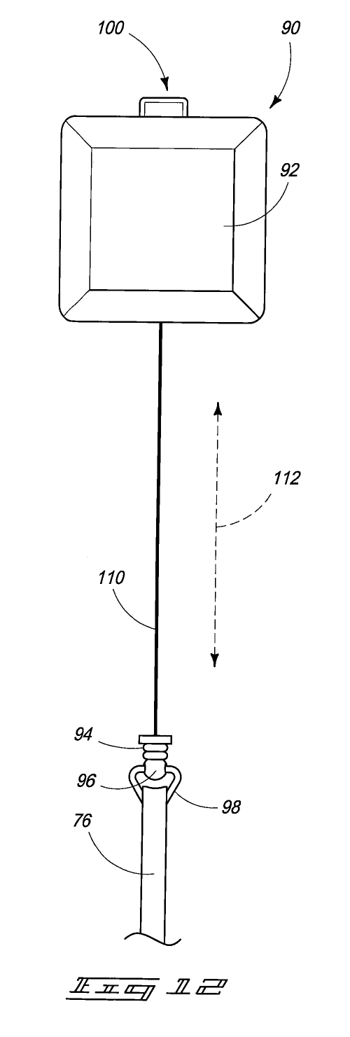

Referring to FIG. 9, an exemplary retractable reel 90 is illustrated according to one of various embodiments of the invention wherein ring 98 is shown in a closed orientation and received in the opening of receiving ball 96. Exemplary dimensions for an exemplary retractable reel 90 include a width dimension of about 1¼ inch and a length dimension of about 1¼ inch (1¼ inch square) and a thickness (see FIG. 10) of about 5/16 inch.

Referring to FIG. 10, the side 102 of exemplary retractable reel 90 is illustrated according to one of various embodiments of the invention and further illustrates the attachment clip 100 as being an alligator clip. Attachment clip 100 includes a base 106 secured to body 92 of retractable reel 90 and an articulation portion 104 pivotably secured to base 106.

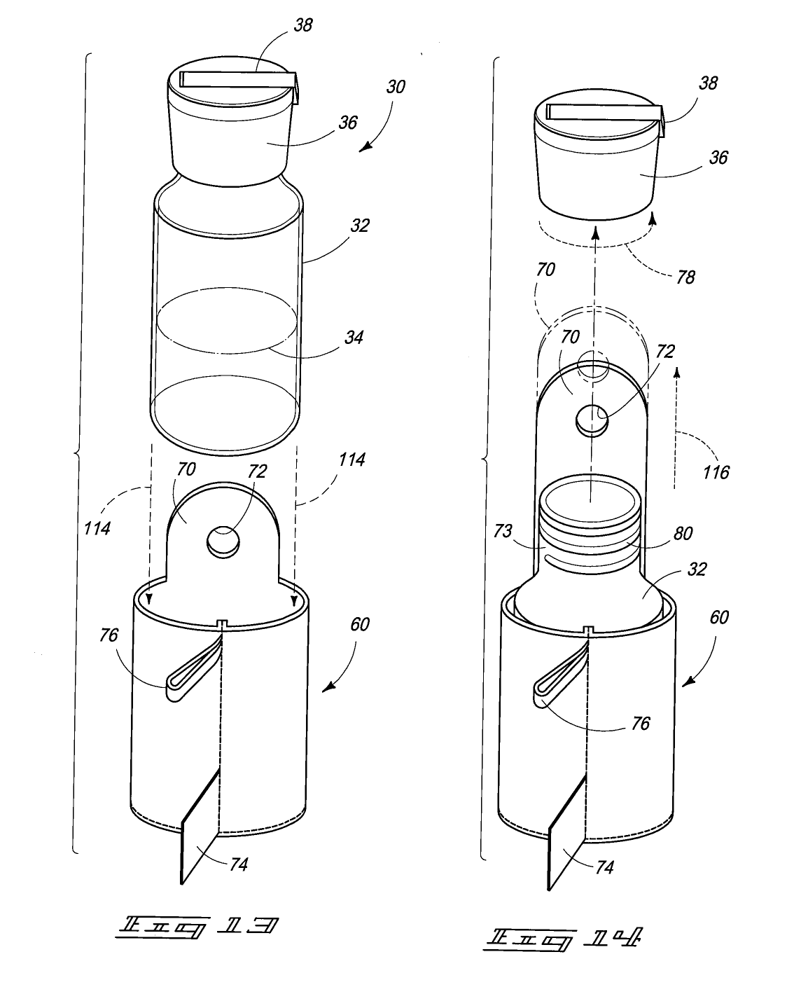

Referring to FIG. 11, an exemplary side of retractable reel 90 opposite the side shown in FIG. 9 is illustrated and includes attachment clip 100 according to one of various embodiments of the invention. This view demonstrates that the exemplary attachment clip 100 has the capability to rotate in a direction 108 that comprises a total of 360 degrees.

Referring to FIG. 12, an exemplary retractable reel 90 is illustrated according to one of various embodiments of the invention with strip of material 110 shown at least partially removed from body 92 of retractable reel 90. Strip of material 110 can move reciprocally in either direction 112 and is biased to move toward body 92, for example, via the influence of a spring (not seen) in the body 92 of retractable reel 90. Exemplary materials for strip of material 110 include at least one of the following: various cloth and fabric materials; various fibrous and threaded materials; various rubbers; various synthetic rubbers such as neoprene; various nylon materials; and various leathers.

Still referring to FIG. 12, some embodiments of material for the strip of material 110 can include expandable material which means the strip of material 110 expands in the lengthwise direction of the strip of material 110. Alternatively, other embodiments of the strip of material 110 include unexpandable material which means the strip of material 110 does not expand in the lengthwise direction of the strip of material 110. An exemplary strip of material 110 is a cord and has an exemplary length dimension of about 30 inches. Other aspects and implementations of exemplary dimensions for exemplary strips of material 110 are contemplated.

Referring to FIG. 13, an exemplary embodiment of a method step of providing container 30 in cover (receptacle) 60 is illustrated according to one of various embodiments of the invention. The right end 63 (see FIG. 7) is brought to meet left end 65 (see FIG. 7) and sewn or glued together, including the bottom portion of cover 60, to form receptacle 60. In a next exemplary method step according to one of various embodiments of the invention, container 30 is moved along direction 114 to be positioned in receptacle 60.

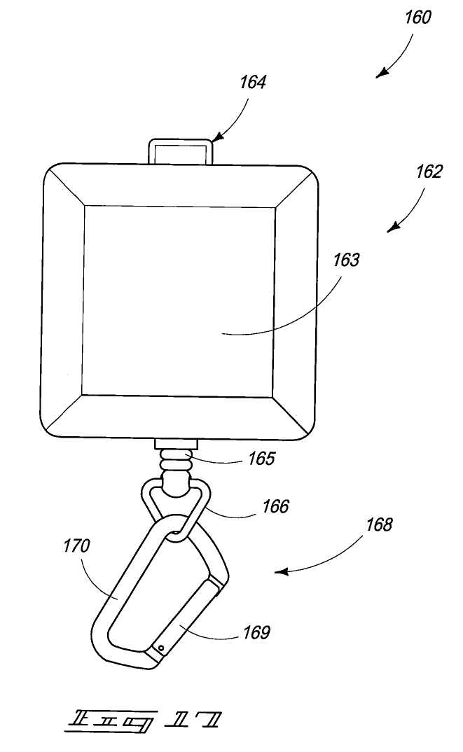

Referring to FIG. 14, an exemplary embodiment of a method step of providing container 30 in cover (receptacle) 60 is illustrated according to one of various embodiments of the invention. Top 36 is removed from neck 73 of container 30 by rotating (unscrewing) top 36 in a counterclockwise direction 78 from threads 80 of neck 73. Still further, top 36 is moved along direction 116 away from neck 73. Upper curved portion 70 of cover 60 is moved upward or stretched along direction 116. In another embodiment of the invention, top 36 is removed or unscrewed from neck 73 of container 30 during method step of FIG. 13 instead of method step disclosed in FIG. 14.

Referring to FIG. 15, an exemplary embodiment of a method step of providing container 30 in cover (receptacle) 60 is illustrated according to one of various embodiments of the invention. After being stretched upwardly along direction 116, upper curved portion 70 of cover 60 is pulled downwardly generally in direction 118 toward and over neck 73 of container 30 by allowing opening 72 to receive neck 73. The force of the pull along direction 118 will expand opening 72 to allow neck 73 of container 30 to pop though opening 72 generally along direction 120. Top 36 is provided onto neck 73 of container 30 by rotating top 36 in clockwise direction 82 along threads 80 of neck 73. As top 36 is moved downwardly onto neck 73, top 36 forces the upper curved portion 70 further downwardly onto neck 73.

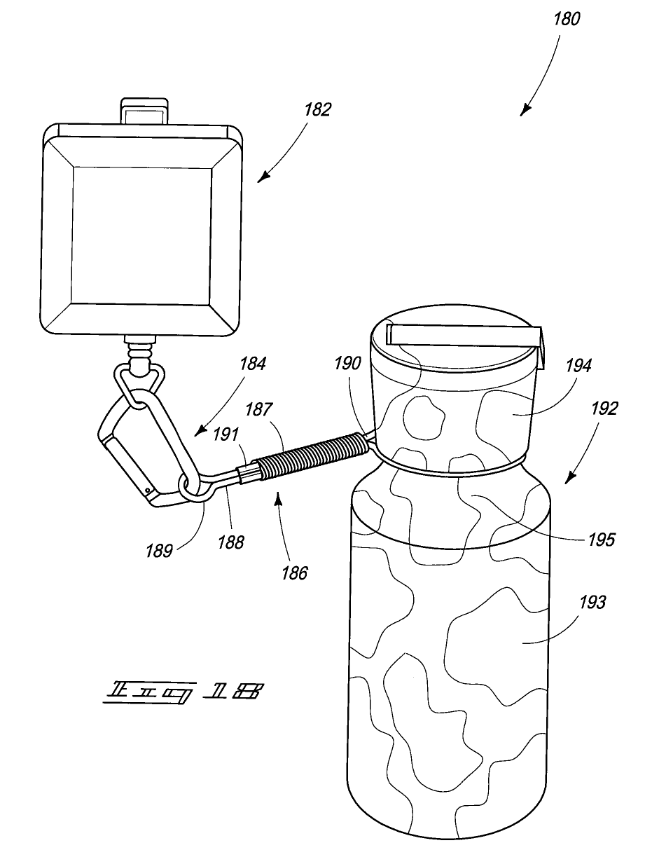

Referring to FIG. 16, an exemplary embodiment of a method step of providing container 30 in cover (receptacle) 60 is illustrated according to one of various embodiments of the invention. Upper curved portion 70 is positioned on neck 73. Moreover, retractable reel 90 is secured onto loop 76 of cover 60. That is, an opened v-shaped ring 98 (see FIG. 7) receives a portion of loop 76 in the “V” portion of v-shaped ring 98 and while maintained therein, opposite ends of the v-shaped ring 98 are placed adjacent opposite sides of opening in receiving ball 96. Next, the v-shaped ring 98 is closed wherein the opposite ends are forced toward each other into the opposite ends of the opening in receiving ball 96. This completes the formation of one exemplary wind detector device according to one of various embodiments of the invention.

Referring to FIG. 17, another exemplary embodiment 160 of structure for an exemplary wind detector device is illustrated according to one of various embodiments of the invention. In this exemplary embodiment, an exemplary retractable reel 162 is shown with a body 163 and clip 164. Additionally, a carabiner or snap-link 168 is provided onto a v-shaped ring 166 which is secured into a receiving ball (not referenced with a number) adjacent a stop 165. Carabiner 168 allows for easy and quick replacement of retractable reels 160 and previously-described covers 60 if necessary. That is, an exemplary carabiner 168 has a metal loop portion 170 and a gate 169. Without having to open and close the v-shaped ring 166, retractable reel 162 can be placed onto the carabiner 168 by forcing the v-shaped ring 166 through gate 169 and onto the metal loop portion 170. Similarly, loop 76 of previously described covers 60 can be moved through gate 169 and onto the metal loop portion 170 of carabiner 168. In this fashion, another exemplary wind detector device is formed according to another one of various embodiments of the invention. It should be understood that while a passive or non-locking carabiner 168 is shown, a locking carabiner could be used in place of the non-locking carabiner 168.

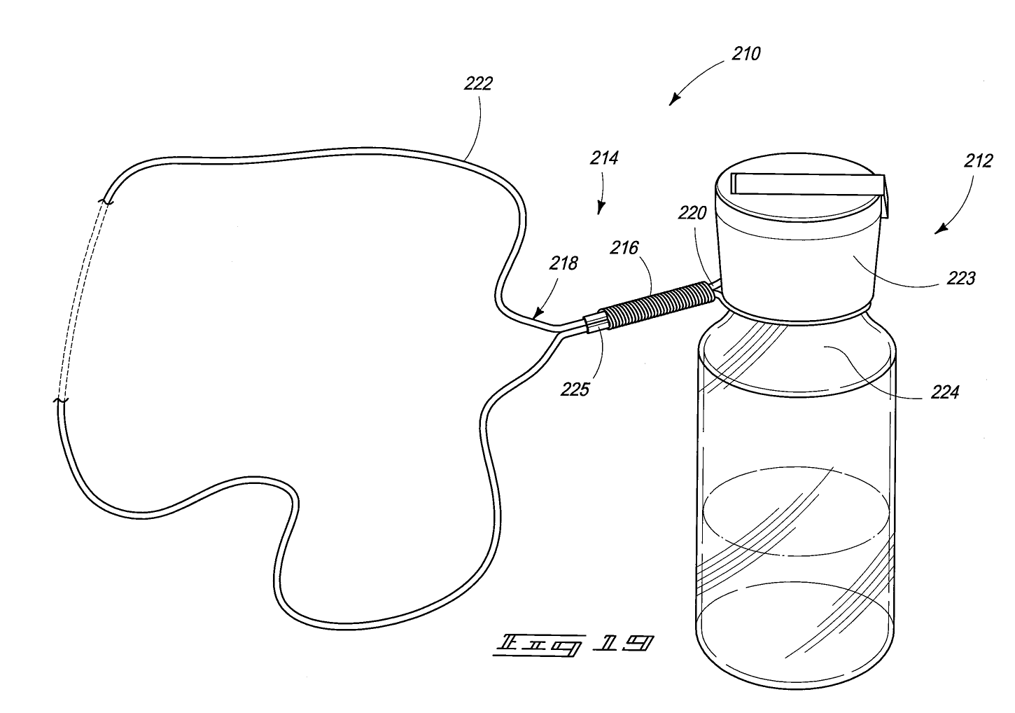

Referring to FIG. 18, another exemplary embodiment of a wind detector device 180 is illustrated according to one of various embodiments of the invention. In this exemplary embodiment, an exemplary retractable reel 182 is secured to a carabiner 184, which is secured to a spring-loaded attachment 186, which is secured to container 192. An exemplary spring-loaded attachment 186 includes a spring 187 against a stop 191 wherein spring 187 is biased toward a first loop 190 of string material 188. In this fashion, first loop 190 is forced to be closed tight or snug around any dimension of structure for which first loop 190 is provided over. First loop 190 is one end of spring-loaded attachment 186 with the opposite end forming second loop 189. The second loop 189 of spring-loaded attachment 186 is provided on carabiner 184 and the first loop 190 is provided on neck 195 of container 192. Since the bottom portion of top 194 has a greater dimension (diameter) than neck 195, first loop 190 is maintained on container 192 by top 194, and ultimately, provides for retractable reel 182 to stay connected with container 192.

It should be noted that this embodiment of wind detector device 180 has no cover and that container 192 includes a camouflage design on its body 193. In other exemplary embodiments of wind detector devices, this exemplary wind detector device could include embodiments of previously-described covers and body 193 could be clear or have other designs and colors.

Referring to FIG. 19, another exemplary embodiment of a wind detector device 210 is illustrated according to one of various embodiments of the invention. In this exemplary embodiment, an exemplary lanyard 214 is secured to a container 212. The exemplary lanyard 214 includes a spring 216 against a stop 225 wherein spring 216 is biased toward a first loop 220 of string material 218. In this fashion, first loop 220 is forced to be closed tight or snug around any dimension of structure for which first loop 220 is provided over. First loop 220 is one end of lanyard 214 with the opposite end forming second loop 222. An exemplary second loop 222 will have any dimension of loop desired, and in one embodiment, will be dimensioned to be provided over the head of a hunter to rest on the hunter's shoulders around the neck. The first loop 220 is provided on neck 224 of container 212. Since the bottom portion of top 223 has a greater dimension (diameter) than neck 224, first loop 220 is maintained on container 212 by top 223.

It should be noted that this embodiment of wind detector device 210 has no cover and that container 212 includes a clear body. In other exemplary embodiments of wind detector devices, this exemplary wind detector device could include embodiments of previously-described covers and the body of container 212 could have a camouflage design or other designs and colors.

It should be understood that for some embodiments of lanyard 214, the string material 218 can include expandable material which means the string material 218 expands in the lengthwise direction of the string material 218. Alternatively, other embodiments of the string material 218 include unexpandable material which means the string material 218 does not expand in the lengthwise direction of the string material 218.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A wind detector device comprising:
a container comprising an interior and a nozzle in fluid communication with the interior; and
fire extinguisher powder in the interior of the container.

2. The device of claim 1 wherein the nozzle is configured to pivot between an open position and a closed position, the open position establishes the fluid communication between the nozzle and the interior of the container, the closed position impedes the fluid communication between the nozzle and the interior of the container.

3. The device of claim 1 wherein the interior of the container further comprises at least one of the following substances: soil, talcum powder, baking soda, scented agents and any combination of these substances.

4. The device of claim 1 further comprising a strip of material comprising first and second ends, the first end is secured to the container.

5. The device of claim 4 wherein the second end of the strip of material is configured for securement to a support structure.

6. The device of claim 4 wherein the strip of material comprises material that is expandable in the lengthwise direction of the strip of material.

7. The device of claim 4 wherein the strip of material comprises material that is unexpandable in the lengthwise direction of the strip of material.

8. The device of claim 4 further comprising a retractable reel having a biased reel wherein the second end of the strip of material is secured to the biased reel, the biased reel is rotatably configured to roll substantially an entire length of the strip of material into a body of the retractable reel.

9. The device of claim 4 further comprising a receptacle to receive at least a portion of the container, and wherein the first end of the strip of material is secured to the receptacle.

10. The device of claim 4 further comprising:
a receptacle to receive at least a portion of the container, wherein the first end of the strip of material is secured to the receptacle;
a retractable reel comprising body and a biased reel rotatably secured within the body, wherein the second end of the strip of material is secured to the biased reel, the biased reel configured to roll substantially an entire length of the strip of material into the body of the retractable reel; and
a clip attached to the body of the retractable reel and configured to secure the retractable reel and container to a support structure.

11. The device of claim 9 wherein the receptacle comprises neoprene.

12. The device of claim 10 wherein the support structure comprises an article of clothing.

13. A wind detector device comprising:
a container comprising an interior and a nozzle in fluid communication with the interior;
powder in the interior of the container; and
a strip of material comprising first and second ends, the first end secured to the container and the second end configured to be secured to a support structure.

14. The device of claim 13 wherein the strip of material comprises material that is expandable in the lengthwise direction of the strip of material.

15. The device of claim 13 wherein the strip of material comprises material that is unexpandable in the lengthwise direction of the strip of material.

16. The device of claim 13 further comprising a retractable reel, the retractable reel comprising a body and a biased reel rotatably secured within the body, wherein the second end of the strip of material is secured to the biased reel, the biased reel configured to roll substantially an entire length of the strip of material into the body of the retractable reel.

17. A method of detecting wind comprising:
providing a wind detector device comprising:
a container comprising an interior and a nozzle in fluid communication with the interior;
powder in the interior of the container;
a strip of material comprising first and second ends, the first end secured to the container;
a retractable reel comprising a body and a biased reel rotatably secured within the body, wherein the second end of the strip of material is secured to the biased reel, the biased reel configured to roll substantially an entire length of the strip of material into the body of the retractable reel; and
a clip secured to an outer portion of the body of the retractable reel; and
using the clip to secure the retractable reel to an article of clothing;
unrolling the strip of material from the retractable reel by pulling the container away from the retractable reel; and
squeezing the container to force a portion of the powder in the interior of the container to exit through the nozzle into the environment.

18. The method of claim 17 further comprising, after the squeezing, allowing the biased reel to reroll the strip of material into the body of the retractable reel with the container returning to be supported proximate the article of clothing.
